(19) United States
(12) Patent Application Publication
(10) Pub. No.: US 2025/0254041 A1
(43) Pub. Date: Aug. 7, 2025

(54) DEVICE, SYSTEM, AND METHOD TO GENERATE HUMAN-DISCERNIBLE INFORMATION HAVING MACHINE VERIFIABLE METADATA

(71) Applicant: 3NUM Inc., Austin, TX (US)

(72) Inventor: Christopher Daniel Boscolo, Austin, TX (US)

(73) Assignee: 3NUM Inc., Austin, TX (US)

(21) Appl. No.: 18/854,066

(22) PCT Filed: Apr. 4, 2023
(86) PCT No.: PCT/US23/65344

§ 371 Date: Oct. 4, 2024

Related U.S. Application Data
(60) Provisional application No. 63/362,456, filed on Apr. 4, 2022.

(51) Int. Cl. H04L 9/14

(52) U.S. Cl. CPC H04L 9/14

(57) ABSTRACT

An encoded human readable datum (EHRD) can be generated wherein the creator of the EHRD maintains control over the metadata associated with the EHRD. This metadata can be used to inform service providers how to send and receive communications with the owner of the EHRD. The metadata data associated with this EHRD can be updated. Controlling who can update the metadata associated with the EHRD is secured using cryptography, blockchain technology, or cryptography and blockchain technology.

### BACKGROUND

### Technical Field

The present disclosure generally relates to the control of information that is intellectually discernible by a human being including, but not limited to, phone number and geolocation data. More particularly, but not exclusively, the present disclosure relates to devices, systems, and methods that generate, read, verify, or otherwise cooperate associate with, control, or act in association with human-discernible information having metadata that is controlled by a user and protected via cryptographic, distributed ledger, or cryptographic and distributed ledger technologies.

### Description of the Related Art

Human-discernible information is ubiquitous in user-centric computing systems. Smartphones, tablets, desktop computers, automobile dashboard computers, kiosks, electronic cash registers, and the like all receive and present human-discernible information via an electronic system such as a display screen. In these cases, once entered in system, the human-discernible information is controlled by the system. For example, if a human user enters a name or birth date into a system, metadata information such as font, text size, a time-tag, and the like are all controlled by the system.

All of the subject matter discussed in the Background section is not necessarily prior art and should not be assumed to be prior art merely as a result of its discussion in the Background section. Along these lines, any recognition of problems in the prior art discussed in the Background section or associated with such subject matter should not be treated as prior art unless expressly stated to be prior art. Instead, the discussion of any subject matter in the Background section should be treated as part of the inventor's approach to the particular problem, which, in and of itself, may also be inventive.

### BRIEF SUMMARY

The following is a summary of the present disclosure to provide an introductory understanding of some features and context. This summary is not intended to identify key or critical elements of the present disclosure or to delineate the scope of the disclosure. This summary presents certain concepts of the present disclosure in a simplified form as a prelude to the more detailed description that is later presented.

The device, method, and system embodiments described in this disclosure (i.e., the teachings of this disclosure) enable the generation, communication, and use of properly formatted human-discernible data (e.g., numbers, alphanumeric combinations, phone numbers (e.g., having E.164 formatting), geolocation data (e.g., Open Location Code), and the like) wherein the user generating the data (i.e., the data “owner”) retains control over the metadata associated with the data using cryptography, blockchain technology, or cryptography and blockchain technology.

In a first embodiment, a mobile device secure communications method, includes providing a first secure communications application in a memory device of a first mobile computing device, and executing software instructions of the first secure communications application. The executing is arranged to carry out the acts of: requesting at least one identification number, selecting an identification number from the at least one identification number, receiving a hash of the identification number from a registrar, the registrar having signed the hash of the identification number, signing a transaction involving the identification number, and directing registration of the hashed and signed version of the identification number on a blockchain smart contract using a public key controlled with a private key associated with a first user, wherein the registering causes the registrar to store a public number hash of the identification number, a controller public key associated with the identification number, and a representation of a first encoded human readable datum (EHRD) associated with the identification number.

In some cases of the first embodiment, the identification number is a telephone number. In some of these cases, the telephone number has an E.164 format. Sometimes, the representation of the first encoded human readable datum (EHRD) is a profile picture having hashed data embedded therein. And sometimes requesting at least one identification number includes requesting at least two identification numbers and selecting the identification number includes selecting one of the at least two identification numbers.

In other cases of the first embodiment, executing the software instructions is further arranged to carry out the acts of: accepting a second identification number at the first mobile computing device, performing a hash on the second identification number, directing a look-up to determine if a version of the hashed second identification number is found on the blockchain smart contract, based on finding the version of the hashed second identification number on the blockchain smart contract, generating ephemeral key pairs, and using the ephemeral key pairs to establish and conduct encrypted communications between the first mobile computing devices and a second mobile computing device.

And in still other cases, software instructions are further arranged to carry out the acts of: retrieving a representation of a second encoded human readable datum (EHRD) associated with second the identification number, and displaying on a user interface verified and unverified identification numbers. Sometimes, the software instructions are further arranged to carry out the acts of: receiving at the first secure communications application a request to connect, the request including a third identification number signed with a private key, performing a hash on the third identification number, directing a look-up to determine if a version of the hashed third identification number is found on the blockchain smart contract, and based on finding the version of the hashed third identification number on the blockchain smart contract, providing the first user with an opportunity to accept the request to connect. And sometimes, executing the software instructions is further arranged to carry out the acts of: based on finding the version of the hashed third identification number on the blockchain smart contract, retrieving a representation of a third encoded human readable datum (EHRD) associated with the third identification number.

In a second embodiment, a non-transitory computer-readable storage medium whose stored contents configure a computing system to perform a method, the method comprising: processing digital information from a first device, said information including a request from the first device to access to a first descriptor file, isolating a human readable datum arranged as a set of N alphanumeric digits, wherein N is an integer greater than 7, encoding the human readable datum into a first encoded human readable datum (EHRD), the first EHRD being arranged as a system-wide unique M-bit alphanumeric sequence, wherein M is an integer greater than N, determining whether the first EHRD is present on a certain blockchain, the certain blockchain hosting a system-wide registry of EHRDs, based on a successful determination that the first EHRD is present on the certain blockchain, retrieving a first system-wide unique L-bit hash from a determined distributed hash table (DHT) structure, wherein L is an integer greater than M, and using the first system-wide unique L-bit hash, communicating the first descriptor file or information associated with the first descriptor file to the first device requesting access to the first descriptor file.

In some cases of the second embodiment, N is at least 15, M is at least 48, and L is at least 256. In some cases, the human readable datum represents a numeric telephone number. And in some cases, the method further includes retrieving, from the descriptor file, communication parameters associated with communicating data between a second device and the first device.

This Brief Summary has been provided to describe certain concepts in a simplified form that are further described in more detail in the Detailed Description. The Brief Summary does not limit the scope of the claimed subject matter, but rather the words of the claims themselves determine the scope of the claimed subject matter.

### BRIEF DESCRIPTION OF THE SEVERAL VIEWS OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. One or more embodiments are described hereinafter with reference to the accompanying drawings in which:

FIG. 1 is a first computational environment embodiment where two or more users would like to securely communicate;

FIG. 2 is a second computational environment embodiment that includes one or more computing devices arranged to generate an EHRD;

FIG. 3 is a third computational environment embodiment that includes one or more computing devices arranged to register a number for secure use;

FIG. 4 is a fourth computational environment embodiment arranged to securely communicate with another user;

FIG. 5 is a fifth computational environment embodiment arranged to verify contact information from a person or entity not previously known; and

FIG. 6 is an embodiment of a communication device of the type disclosed in the present disclosure.

### DETAILED DESCRIPTION

The present disclosure may be understood more readily by reference to this detailed description and the accompanying figures. The terminology used herein is for the purpose of describing specific embodiments only and is not limiting to the claims unless a court or accepted body of competent jurisdiction determines that such terminology is limiting. Unless specifically defined in the present disclosure, the terminology used herein is to be given its traditional meaning as known in the relevant art.

In the following description, certain specific details are set forth to provide a thorough understanding of various disclosed embodiments. However, one skilled in the relevant art will recognize that embodiments may be practiced without one or more of these specific details, or with other methods, components, materials, etc. In other instances, well-known structures associated with computing systems, including client and server computing systems as well as networks, have not been shown or described in detail to avoid unnecessarily obscuring more detailed descriptions of the embodiments.

Web3, which may also be referred to by other names such as Web 3.0, Web Next, or other like terms refers to the third significant evolution of the World Wide Web.

The first generation of the web was characterized by static, non-moving web pages that were updated only when a web author created a new page and uploaded the new page to an internet server. The second generation introduced dynamic, interactive web applications. The third generation, which is in its infancy, represents a shift towards a decentralized, peer-to-peer internet where individuals are empowered to own and control their digital identities and assets.

Web3 will be driven by emerging technologies such as virtual networks, encrypted data paths, blockchain, decentralized computing, and smart contracts, among other technologies, which will enable the creation of decentralized applications (dApps) that operate independently of centralized intermediaries. This emerging architecture allows for increased privacy, security, and transparency in digital transactions and interactions.

The present inventor has recognized that Web3 technologies will also enable the creation of decentralized finance (DeFi) applications, decentralized communication, decentralized social networks, decentralized storage solutions, and other applications that prioritize user control and privacy when users can form a trusted network relationship. The present inventor has further recognized that Web3 users do not have an easy and secure way to communicate. To solve this problem, the present inventor has developed a novel and never-before seen mechanism that improves network computing in a way that allows users to communicate with each other using only human-discernible information such as telephone numbers, personal identifiers, non-fungible tokens (NFTs), Ethereum Name Service (ENS) names, blockchain wallet addresses, and other such information.

In the present disclosure, the terms, “human-discernible information” and “human-readable information” are used interchangeably. In this disclosure, the terms “discernible” and “readable” are used interchangeably. Information that is discernible (i.e., readable) is information that is perceptible by the senses or intellect. Further, information that is discernible (i.e., readable) is information that may be noticed, perceived, recognized, and distinguished from other information. Information that is perceptible by the senses or intellect. Conventional “reading,” which includes looking at and comprehending the meaning of written or printed words or other characters (e.g., logograms, hieroglyphs, and the like) of any particular alphabet is a type of discerning, but discerning is not limited to only conventional reading.

The device, method, and system embodiments described in this disclosure (i.e., the teachings of this disclosure) enable the generation, manipulation, propagation, or other such activity of human-discernible information having machine verifiable, user controllable metadata. The human-discernible information may include numbers, alphanumeric combinations, standardized telephone numbers (e.g., telephone numbers having E.164 formatting), non-standard communication identifiers (e.g., non-standard telephone numbers, WHATSAPP identifiers, usernames, and the like), geolocation data (e.g., Open Location Code), non-fungible tokens (NFTs), Ethereum Name Service (ENS) names, a digital image having non-visible embedded data, blockchain wallet addresses, and other such information. The user generating the information, which in at least some cases is the owner of such information, retains control over the metadata associated with the information. The control may be via cryptography, blockchain technology, cryptography and blockchain technology, or by one or more additional or alternative mechanisms.

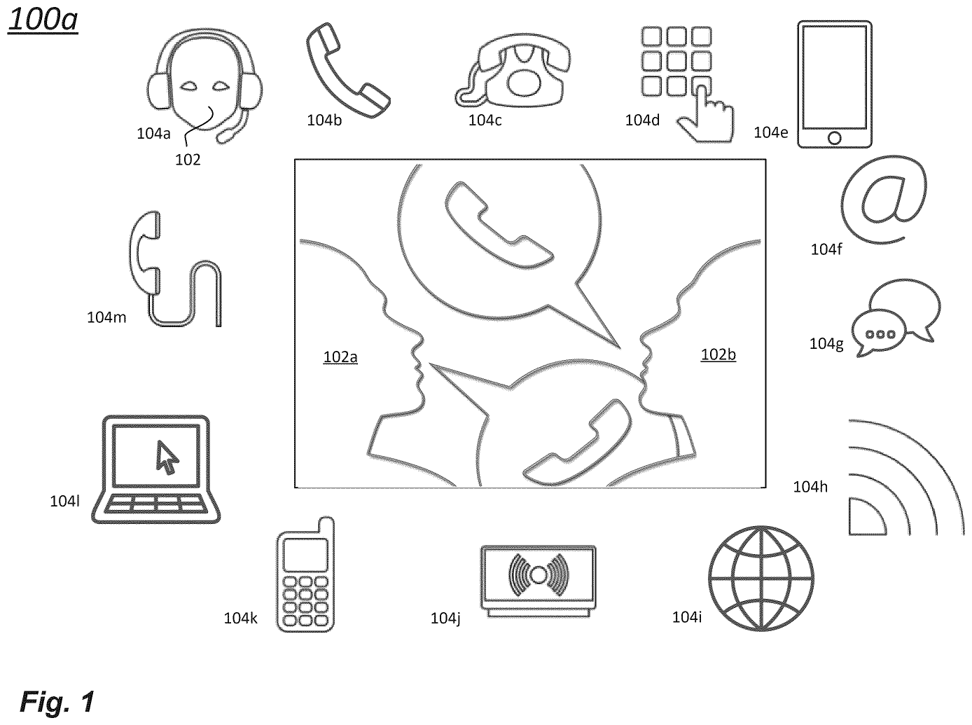

FIG. 1 is a first computational environment 100a embodiment where two or more users 102a, 102b would like to securely communicate. The communication session between the first user 102a and the second user 102b may be relative to an audio communication session such as an internet-based telephone call, a video communication session, an audiovisual communication session, a text-based communication session, a secure digital data transfer (e.g., a banking transaction, smart contract transaction, a transfer of health information, a communication of sensitive data, or any other such communication session).

In the computational environment 100a, the communicating devices may include any type of processor-based computing device capable of communicating electronically. The electronic communication may employ any suitable electronic hardware in any suitable configuration. The electronica communication may employ any suitable software communications protocol. A set of exemplary and non-limiting embodiments are presented in FIG. 1. The embodiments include a user 102, who may be the first user 102a, the second user 102b, or any other user.

Users 102 may communicate according to the teaching of the present disclosure using any suitable short-range protocol and medium 104a; users 102 may communicate using a handset 104b of any suitable configuration; users 102 may communicate using non-mobile communication devices 104c such as an office telephone coupled to a private branch exchange (PBX) or other such system; users 102 may communicate using a touch-based device 104d such as typing a short-message-service (SMS) text message; users 102 may communicate using a smartphone 104e; users 102 may communicate over a wide area network on social media 104f (e.g., TWITTER, FACEBOOK, INSTAGRAM, LINKEDIN, and the like); users 102 may communicate using a direct messaging application 104g (e.g., SIGNAL, PERISCOPE); users 102 may communicate using any suitable mid-range protocol and medium 104h (e.g., IEEE 802.11 WiFi); users 102 may communicate using any suitable long-range protocol and medium 104i (e.g., short-wave radio, satellite communications, light-based communications); users 102 may communicate using conventional high-speed computer based communications 104j (e.g., the internet deployed over a local area network (LAN), a cable high-speed network, a fiber-optic network); users 102 may communicate using a digital radio-frequency (RF) handset 104k such as a walkie-talkie; users 102 may communicate using a mobile device 1041 (e.g., laptop computer, tablet, wearable computing device, vehicle-based device, or the like); and users 102 may communicate using any other communication device or combination of devices 104m, which may be conventional devices or devices not yet known but which deploy the teaching of the present disclosure when such devices are known.

An introduction to the innovative teaching of the present disclosure is now provided. This teaching in this introduction may be included in at least some embodiments, but said teaching is not necessarily included in all embodiments. In at least some of these cases, secure, private communication occurs between a first user and a second user wherein a trusted communication session is instantiated via a human-discernible datum such as a conventional telephone number.

In some cases, human readable information is referred to as an encoded human readable datum (EHRD). The EHRD may be of any suitable length and any suitable encoding. The EHRD may be formed from an alphanumeric combination. In embodiments described in the present disclosure, the EHRD is, or appears as, a conventional telephone number, but those of skill in the art will recognize that the invention is not so limited.

Embodiments of the present invention may include at least one data structure describing the metadata associated with the EHRD. This metadata can include cryptographic keys used for updating this metadata. This metadata can include information about how to communicate with the owner of the EHRD. This metadata can include information associated with the EHRD that the owner of the EHRD can update or allow others to update.

These and other embodiments of the present invention may include one or more blockchain for registering these EHRDs. These and other embodiments of the present invention may include one or more distributed hash tables (DHTs) arranged to distribute metadata associated with the EHRD (e.g., IPFS). As understood by those of skill in the art, blockchain means, hash table means, and other such means include electronic circuitry having at least one processing device and memory. The memory is used to store software instructions executable by the at least one processing device. Ones of skill in the art will recognize that the electronic circuitry will also include power supply circuitry, data path circuitry, switching circuitry, clocking circuitry, and other such logic. Ones of skill in the art will recognize that the memory will store other information in addition to processor-executable instructions.

Embodiments of the present disclosure may be arranged to include a method for encoding the data structure describing the metadata associated with the EHRD. The encoding is arranged to result in a cryptographically verified and properly formatted EHRD. Such proper formatting may include, in some cases, an E.164 formatting in the base of a telephone number. Sometimes, this method uses a one-way hash function to form a generated EHRD that is uniquely generated from the owner's metadata. Such method can include acts to uniquely identify each EHRD type. Such method may contain logic to provide the human-discernible portion of the EHRD. In such case, the uniqueness of any such value (e.g., a unique EHRD) may be a system-wide uniqueness. In some cases, a system-wide uniqueness may be country-wide uniqueness, world-wide uniqueness, or some other degree of uniqueness.

In some embodiments, blockchain technology is provided to register the cryptographically verified EHRD. Such blockchain logic may be arranged to enforce the rules for registering cryptographically valid EHRDs such as telephone numbers. The blockchain logic may enforce rules used to update registered entries. The blockchain logic may further enable the owner of an EHRD to transfer full or partial rights (e.g., ownership) to a new owner. In these and other cases, the blockchain logic may be used to recover control of the EHRD if the owner cryptographic key is lost. In these or still other cases, a user can look up the short human-discernible form of the EHRD in the blockchain to obtain the long-form full hash version of the EHRD.

In some embodiments, the one or more distributed hash tables (DHTs) are arranged to store the metadata associated with the EHRD. In these cases, a user can look up the metadata associated with the EHRD using the full hash version of the EHRD.

Some embodiments include a method to encode updates to the metadata such that the previous version of the metadata can be used to trace all updates going back to the original.

One embodiment includes a method of generating a telephone number. The telephone number in this case is an EHRD. Here, the creator of the EHRD (i.e., the telephone number) maintains control over the metadata associated with the EHRD. This metadata can be used to inform service providers how to send and receive communications with the owner of the EHRD (i.e., the telephone number). The method includes a means to update the metadata data associated with this EHRD (i.e., the telephone number).

Controlling who can update the metadata associated with the EHRD is secured using cryptography and blockchain technology.

Creating and managing a human readable self-secured EHRD may include the acts of: 1) Creating an EHRD with its associated metadata; 2) Registering the EHRD; 3) Updating the metadata associated with an EHRD; and 4) Looking up the metadata associate with an EHRD.

With respect to the first act of creating and managing a human readable self-secured EHRD (i.e., 1. Creating an EHRD with its associated metadata), embodiments of the present invention may be arranged to perform a particular set of sub-acts. Some of the sub-acts may be required; others may be optional. In at least one embodiment, the first act of creating and managing a human readable self-secured EHRD includes up to six or more sub-acts.

A first sub-act includes creating a data structure that contains: a) A nonce used to produce different cryptographic hashes; b) Configuration information about how to securely send and receive messages and/or calls to/from this EHRD; c) Cryptographic keys used to authenticate the controller (e.g., an elliptic curve public key); d) Reference to the previous version of the data structure to enable secure updates to the configuration information; e) Backup authentication information; and f) Other data the controller wants to include. One of skill in the art will recognize that the data structure may include additional information. One of skill in the art will further recognize that any one or more of the nonce, the configuration information, the cryptographic keys, the previous version reference, the backup information, and the other data is optional.

A second sub-act includes encoding the data structure. In at least one case, such encoding includes encoding the data structure into a series of bytes using a deterministic encoding scheme.

A third sub-act includes computing a cryptographic digest hash over the encoded data structure.

In a fourth sub-act, the first N bits of the hash are used as the human-discernible portion of the EHRD. For example, the EHRD can match the proper telephone number format when represented in a human-discernible form. To perform this fourth sub-act, for example, the first N bits may be converted to an EHRD in human-discernible format (e.g., a decimal number for a United States telephone phone number, a base-20 number for an open location code (OLC) number). In at least some cases, the proper format can be one where decimal digits of a telephone number form the proper top-level country code in E.164 format. (e.g., +22 123-456-789-0123).

In a fifth sub-act, if the digits do not form a proper EHRD (e.g., a telephone number with the valid top-level country code), the nonce may be modified and sub-acts three, four, and five may be repeated.

In a sixth sub-act, the first N bits system-wide uniquely identify the human readable portion of the EHRD (e.g., the telephone number), but the entire hash is registered on a blockchain and used to look up the metadata in one or more distributed hash tables (DHTs).

With respect to the second act of creating and managing a human readable, self-secured EHRD (i.e., 2. Registering the EHRD), the EHRD is registered on a blockchain. Here, the shortened human-discernible EHRD may be too short to ensure all self-generated EHRDs in a particular system-wide set remain cryptographically unique. To address this possible issue in some cases, the entire hash of the created EHRD is registered on a blockchain such that the system-wide uniqueness of the human-discernible portion to a desired shortened level can be achieved. By performance of this second act, the blockchain tracks all EHRDs that have been registered.

With respect to the third act of creating and managing a human readable self-secured EHRD (i.e., 3. Updating the metadata associated with an EHRD), metadata of the EHRD is updated. Here, for example, the initial data structure that is encoded and cryptographically hashed to generate the human-discernible EHRD contains metadata information used by others. One such metadata might be used to determine how to send and receive digital communications with the certain individual (e.g., the person that created the EHRD, the person who owns the EHRD, or the like). In some cases, the owner of the

EHRD (e.g., the owner of the telephone number embodied in the EHRD) needs to update this metadata. Updates to the authentication information may also be done by the controller to transfer control of this EHRD (e.g., the telephone number) to another person or entity.

And with respect to the fourth act of creating and managing a human readable self-secured EHRD (i.e., 4. Looking up the metadata associate with an EHRD), metadata associated with an EHRD may be looked up. For example, when a user wants to communicate with the owner of a certain EHRD (e.g., a telephone number), the user must first access the most up-to-date metadata associated with the EHRD. Given the shortened human-discernible portion of the EHRD, the user may look up the shortened EHRD on the blockchain to obtain the current full hash of the EHRD. Additionally, or alternatively, the user may look up the metadata in the DHT.

A more detailed exemplary use case of the devices, systems, and methods to generate human-discernible information having machine verifiable metadata is now presented.

Wendy, a whistleblower, is meeting an investigative journalist, Janice, at a local coffee shop to disclose information about some illicit activity going on at her workplace. Wendy has never met Janice. Wendy was told to meet the red-headed woman at the corner table of a local coffee shop.

Wendy found Janice at the corner table and shared with her an overview of the activity she has witnessed. Wendy informs Janice that she has many digital photos and electronic files on her smartphone supporting her allegations. Wendy asks Janice if she can securely send them to her using encryption to avoid any chance that this information might fall into the wrong hands.

Janice shares her secure telephone number with Wendy (i.e., +997 555 1212) and tells Wendy that this telephone number is a secure encoded human readable datum (EHRD) that supports end to end encrypted communications. Wendy installs a certain secure software application on her smartphone that is arranged to perform certain acts associated with EHRDs. Wendy enters Janice's phone EHRD into the contacts section of the software application. Upon recognizing that the +997 country code has been reserved for this new EHRD secure communication protocol, the smartphone software application app looks up the EHRD in the public registry of EHRDs to obtain the cryptographic public key information associated with this EHRD.

In at least one case, the lookup of the EHRD in the public registry of EHRDs can be done with three lookup acts: 1) a first lookup act to generate an M-bit number; 2) a second lookup act to find the M-bit number on the blockchain that hosts the public registry; and 3) a third lookup act to retrieve the descriptor file for the EHRD. In at least some cases, the M-bit number is a 48-bit number, but one of skill in the art will recognize that M may represent any suitable integer.

Considering at least one embodiment of the first lookup act in more detail, the user enters the human readable 997 555 1212 into the software application. The software application converts this EHRD into an M-bit representation of the EHRD. To generate the M-bit EHRD, the human-discernible telephone number portion of the EHRD is first converted to a fifteen (15) digit decimal EHRD. Fifteen digits is an exemplary length, and other lengths are also contemplated. Generation of the 15-digit decimal number in this case is performed as follows. First, the first three digits are read (997) to affirm they are one of the reserved EHRDs for this type of secure communication. In at least one case, (e.g., E.164 encoding), these first three digits are called the country code. These first three digits are used to form the first three digits of the 15-digit EHRD. The remaining digits 5551212 are padded with zeros until the EHRD is twelve digits long (i.e., 000005551212), and the twelve digits are appended to the first three digits resulting in the 15-digit decimal number (i.e., 997000005551212). In other alternative cases, the 15-digit decimal number may be reversed (e.g., 212155500000799) prior to encoding as an M-bit (e.g., 48-bit) EHRD. Reversing the EHRD in at least some cases ensures the prefix “997” can be used without overflowing an M-bit (e.g., 48-bit) EHRD. Upon the appropriate padding, the 15-digit EHRD is encoded as an M-bit (e.g., 48-bit) unsigned integer.

Considering at least one embodiment of the second lookup act in more detail, the M-bit (e.g., 48-bit) EHRD is looked up on the blockchain that hosts the registry. This could be a blockchain with smart contract capabilities such as ETHEREUM. Alternatively, the blockchain could be purpose-built to host an EHRD registry as contemplated herein. Other blockchain embodiments are also considered.

The blockchain keeps a lookup table that maps the M-bit (e.g., 48-bit) EHRD to a system-wide unique hash representing the associated EHRD descriptor file. In at least some cases, the system-wide unique hash is an L-bit hash. In some cases, the L-bit hash is a 256-bit hash, but other lengths are also contemplated. In the present embodiment, an initial system-wide unique L-bit hash (e.g., a 256-bit hash) is generated whenever a new EHRD is registered. A blockchain (e.g., ETHEREUM or some other blockchain) is used as the central source of truth for the mapping between the condensed M-bit EHRD (e.g., 48-bit EHRD in the present example) and the full-length system-wide unique hash of the descriptor file.

In at least some cases, particular optional aspects of the blockchain contemplated herein include: that the blockchain provides an agreed upon order of the transactions used to update the state of this mapping; that when adding new EHRDs to the registry, the blockchain prohibits duplicates (e.g., each M-bit EHDR is system-wide unique; and that when adding a new EHRD, the initial hash is computed from the associated descriptor file.

Considering at least one embodiment of the third lookup act in more detail, the system-wide unique L-bit hash (e.g., 256-bit hash) is then used to lookup the descriptor file for its associated EHRD. The descriptor file can be stored in any suitable distributed hash table file system (e.g., IPFS). The descriptor file contains the cryptographic public key used to communicate securely with the owner of the subject EHRD (e.g., the secure telephone number).

Turning back to the more detailed exemplary use case embodiment now being described (i.e., Janice sharing her secure telephone number with Wendy), there are aspects of the embodiment's approach that provide a commercially acceptable level of security of the process. For example, the EHRD descriptor file can be hashed using a one-hash function such as SHA256. In this way, there is an acceptable level of confidence that only the subject EHRD descriptor file of interest could have produced this particular bit string (e.g., the 256-bit hash). Another aspect in the present process is that the EHRD is encoded into M-bits (e.g., 48 bits) and makes M bits of system-wide unique L-bit hash (e.g., the 256-bit hash). Still one more aspect is that the blockchain provides that each M-bit (e.g., 48-bit) encoding of the EHRD is system-wide unique. One way to provide such limitation is to check during the registration process whether or not the same M-bits string is already in use, and if it is, not allow such already-resident string to be overwritten. And yet one more aspect is that the blockchain can also provide that the descriptor file, when hashed, produces the proper system-wide unique L-bit hash (e.g., the 256-bit EHRD being registered).

In some cases, the blockchain may also generate a visual representation of the system-wide unique L-bit hash (e.g., the 256-bit hash) of the EHRD in the form of a system-wide unique artistic computer image. In some cases, such image may be referred to as an avatar, and such image may be arranged in any suitable format (e.g., SVG, JPG, or the like). Such artistic rendering can be used by humans as a means for remembering the visual avatar associated with this EHRD, which itself may represent a telephone number or some other useful information. The artistic rendering could be created algorithmically, or by incorporating base component sub images where the choice and pattern is derived from the initial system-wide unique L-bit hash (e.g., the 256-bit hash), or by some other mechanism.

An alternate implementation of the optional avatar generation logic described herein may use the initial system-wide unique L-bit hash (e.g., the 256-bit hash) in combination with a public key of the current owner. In such cases, any update to the owner public key will result in a different avatar being generated for the subject EHRD.

The secure software application that Wendy installed on her smartphone is arranged to generate a system-wide unique public/private keypair. The system-wide unique public/private keypair uses the public key to generate a system-wide unique EHRD for Wendy to use when communicating with other users of this secure network. For example, Wendy's system-wide unique EHRD may be +997 777 3434, which she shares with Janice. In addition to this EHRD being shared with Janice, Wendy also shows Janice the beautiful system-wide unique image of a butterfly that represents the blockchain's rendering of the avatar associated with Wendy's EHRD encoded into the butterfly's wings.

Because the Wendy's EHRD is cryptographically derived from, among other things, her public key, the actual EHRD generated here is a very large number (e.g., 2 raised to the power 256), and the number is both too large to efficiently fit on the screen of a small smartphone and too large for the average human to remember. Instead, only a small portion of the EHRD (e.g., +997 777 3434) is shown on the display, thus making efficient use of the display space and memory.

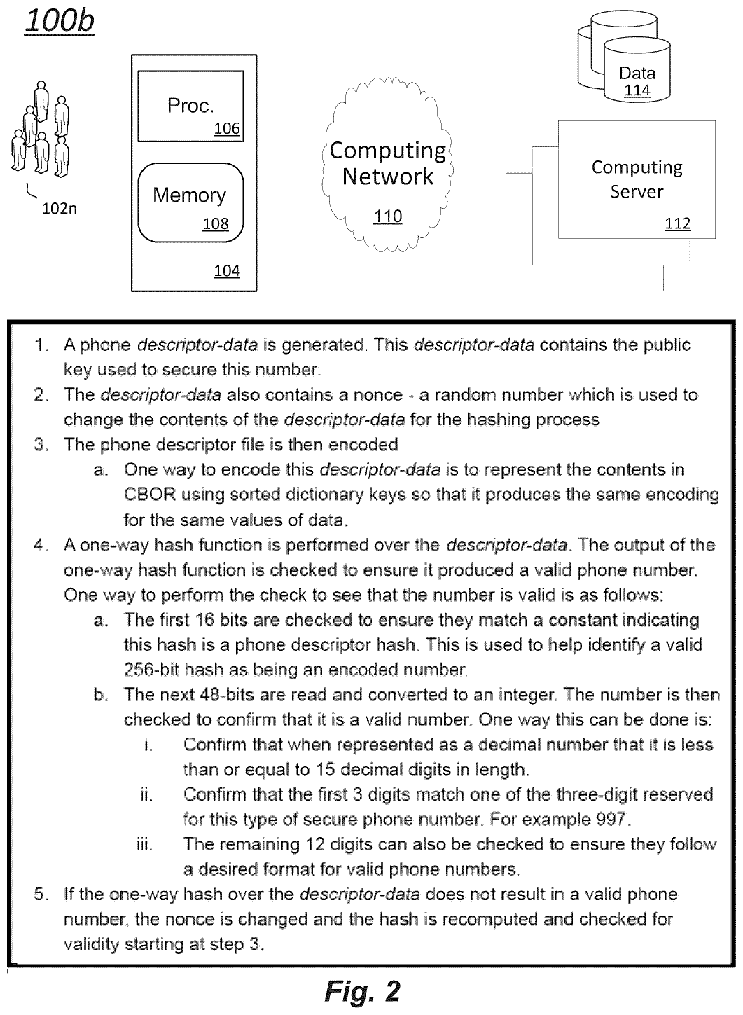

FIG. 2 is a second computational environment 100b embodiment that includes one or more computing devices arranged to generate an EHRD. Any numbers of users 102n may employ any suitable number and type of communication devices 104 to perform secure, private communications. Each communication device 104 includes a processor 106, memory 108, and other circuitry and software not further described. The communication devices 104 communicate via a computing network 110. The users, via the communication devices 104 and computing network 110 optionally interact communicatively with any suitable number of remote computing servers 112, which are arranged to access database structures 114 having any suitable hardware logic and software logic. In the embodiment of FIG. 2, the computing devices (e.g., communication devices 104, remote computing servers 112) may perform hashing algorithms, encryption, decryption, image generation, user interface functions, and the like. The database structures 114 may be arranged to store, among other things, blockchain records, distributed hash tables (DHT), and other such data.

In the embodiment of FIG. 2, an EHRD is generated in five acts via interaction of one or more communication devices 104, computing servers 112, and database structures 114. First, descriptor-data to be associated with a secure telephone number is generated. This descriptor-data contains the public key used to secure the EHRD. Second, a random number nonce is added to the descriptor-data. The nonce is used to change the contents of the descriptor-data for the hashing process. Third, the descriptor file is encoded. One exemplary way to encode the descriptor-data is to represent the contents in concise binary object representation (CBOR) using sorted dictionary keys that produce the same encoding for the same values of data. Other techniques are also contemplated. Fourth, a one-way hash function is performed over the descriptor-data, and the output of the one-way hash function is checked to verify whether or not a valid EHRD was produced. And fifth, if the one-way hash over the descriptor-data does not result in a valid EHRD, the nonce is changed, and the hash is recomputed and checked for validity starting at the third act.

Subsequent to finding valid descriptor-data with a nonce that produces a valid output hash, the descriptor-data is registered on a blockchain. Blockchain registration would involve several acts. For example, a cryptographic digital signature may be performed over the descriptor-data using the private key associated with the public key in the descriptor-data. Next, the blockchain smart contract can verify whether the signature was performed by the public key contained in the “owner” section of the descriptor-data. The smart contract can compute a one-way hash over the descriptor-data, and the output of the one-way hash function can be checked to determine if it produced a valid EHRD. One way, but not the only way, to perform such a validation check on the EHRD is to check that a first number of bits (e.g., 16 bits) match a constant indicating that the subject has a proper format (e.g., a phone descriptor hash). The next M-bits (e.g., 48-bits) can be analyzed and, in some cases, converted to an integer, and the EHRD can then be checked to confirm that it is a valid EHRD. In at least one case, such checking is performed by: a) confirming that when represented as a decimal number, the EHRD is less than or equal to a determined number (e.g., 15) of decimal digits in length; b) confirming that the first 3 digits (e.g., 997) match one of the three-digit combinations (or some other number of digits) reserved for this type of secure EHRD; and c) optionally checking that a set of remaining digits (e.g., 12 digits) can follow a desired format for a valid EHRD (e.g., a telephone number).

Turning once again back to the detailed exemplary use case embodiment of Wendy the Whistleblower described herein (i.e., Janice sharing her secure telephone number with Wendy), in association with the secure software application performing certain functions, Wendy may then select all the photos and documents that she wants to share with Janice. The selected information can be communicated (e.g., added to a text message) to Janice. The secure software application encrypts the information using the cryptographic key that was computed from a selected key exchange protocol (e.g., Elliptic-curve Diffie-Hellman (ECDH) or some other protocol). This key exchange uses Wendy's public key and the public key that is associated with Janice's EHRD. This key exchange protocol will authenticate to Janice that the encrypted contents came from the specific

EHRD (e.g., secure telephone number) that Wendy shared with Janice when they first met.

To send the encrypted data, the secure software application operating on Wendy's smartphone may perform a determined set of communication acts. The communication acts may include: 1) Looking up the descriptor-data associated with Janice's EHRD, which may have been updated by Janice at some point in time after it was originally generated; 2) Optionally confirming that the descriptor-data contains both the public key used to securely send messages to Janice as well as information about where to send the messages so that they will reach Janice; 3) Using the public key to perform a cryptographic key exchange with Janice's public key; 4) Encrypting the data with the key derived from the exchange protocol; and 5) communicating the data to Janice at the destination indicated in the descriptor file, which destination may be a computer address Janice uses to securely receive messages.

Upon receiving a message from Wendy, Janice's smartphone may recognize that it is receiving a first-ever message from Wendy's smartphone. In response to the recognition, Janice's phone may display a message on its screen confirming that she (i.e., Janice) wants to allow messages from this new secure EHRD (e.g., telephone number +997 777 3434). In addition to the EHRD, Janice's smartphone may also display the avatar associated with the subject EHRD (e.g., the same beautiful butterfly Wendy just showed Janice.) Janice, upon seeing the EHRD and the memorable butterfly has confidence that the received message came from Wendy.

To confirm the messages received from Wendy, the software application operating on Janice's smartphone may perform certain confirmation actions. In at least one embodiment, the confirmation acts include: 1) Confirming or in some cases displaying a decoded EHRD (e.g., “+997 777 3434,” a telephone number, a sender address, or the like), which may be derived from the actual sender address (e.g., a system-wide unique L-bit hash (e.g., the 256-bit hash)) of the descriptor-data that Wendy registered on the blockchain; 2) Validating that the initial message is digitally signed using the cryptographic public key contained in the descriptor-data that was used to generate the EHRD; 3) Looking up the descriptor-data in a DHT using the system-wide unique L-bit hash (e.g., the 256-bit hash) or, alternatively, performing a one-way hash algorithm over descriptor-data sent with the initial message, and looking up the hash in the blockchain to determine whether it was registered, and if so, extracting the EHRD from the hash and comparing it to the one in the contact address portion of Wendy's smartphone; 4) Checking the digital signature to determine whether the message was signed by Wendy's public key, which is retrieved from the descriptor-data.

Updating information contained in the descriptor-data can be done by the owner of the smartphone EHRD by generating updated descriptor-data, and signing the updated descriptor-data with the key used to generate the original descriptor file. The updated descriptor file may or may not be registered on the blockchain. In at least one case, such registration depends on whether or not the person wants to share the updated descriptor file only with one or more peers, or if it is intended to be publicly visible by anyone.

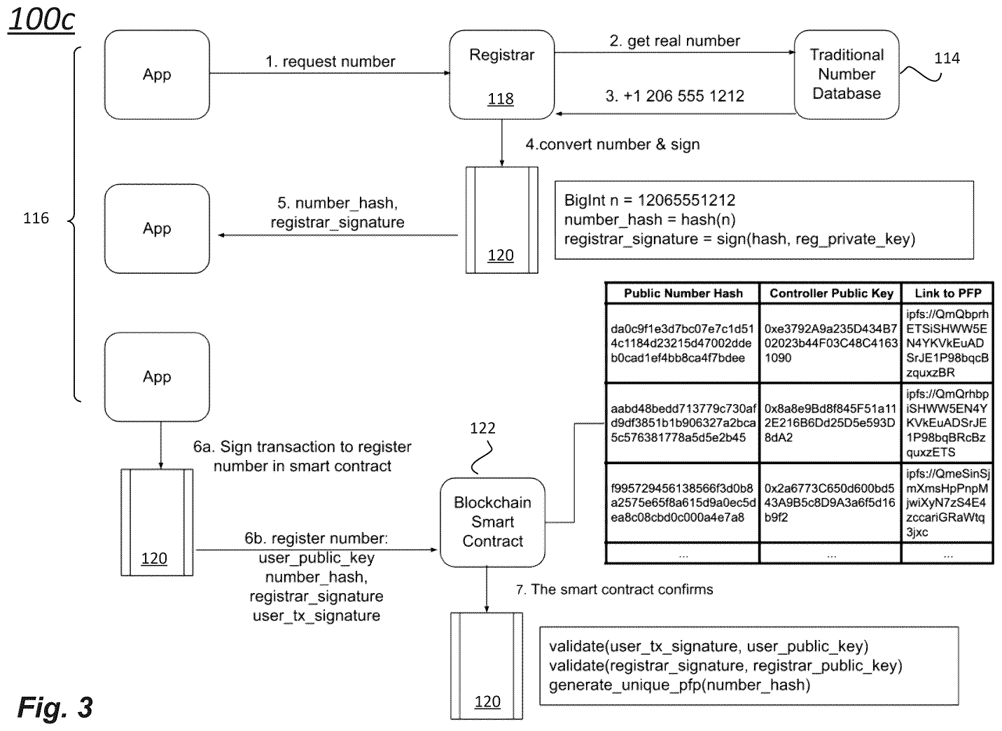

FIG. 3 is a third computational environment 100c embodiment arranged to register a number for secure use. The number is an encoded human readable datum (EHRD), and ones of skill in the art will recognize that any suitable number, phrase, image, or other type of human-discernible data may be interchanged with the “number” of the present embodiment and thereby operate as the EHRD.

In this third computational environment 100c, any suitable number of users 102 (FIG. 2) may use any suitable number and type of communication devices 104 (FIG. 2), remote computing servers 112, and database structures 114 to perform the acts of the embodiment that provide secure and private messaging. The logic presented herein operates on the electronic circuitry described herein to improve the security of the communicating hardware circuitry.

In the third computational environment 100c embodiment, a software application 116 is executing on a communication device 104 such as a smartphone, a tablet, or some other mobile or non-mobile computing device. The software application 116 may be a standalone application, a browser-based application (e.g., a web-app), or some software. In at least some cases, the request for the number begins with a user manipulating a web browser on the communication device 104 to visit a registrar web server operating on a remote computing server 112.

In a first operation (“1. request number”), the application 116 will communicate a request towards the registrar. The registrar is a set of software arranged to receive the request for a secure number (i.e., the EHRD). In some cases, the registrar software is a cloud-based remote computing servers 112.

In a second operation (“2. get real number”), the registrar queries a database 114 that is arranged to store numbers or other EHRD of the type to be requested by a user 102.

In a third operation (“3. +1 206 555 1212”), the database logic 114 returns a number or other EHRD to the registrar 118. The returned number or other EHRD may be selected at random, selected from a list, or selected by any other suitable criteria. In embodiments of the innovation now being described, one or more numbers or other EHRD's are presented to the user 102 for selection. In this way, the user 102 is permitted in at least some cases to select a desired number or other EHRD. Once the number or other EHRD is selected, it is reserved and not usable by any other user 102.

In a fourth operation (“4. convert number and sign”), the registrar will convert the number or other EHRD in a way it will be represented in software. For example, if the number or other EHRD has an E.164 format, the registrar 118 may perform a hash (e.g., a one-way hash or some other hash) over the number or other EHRD to convert the number or other EHRD into an integer that will be used by the registrar's software. Later in this embodiment process, the hash will be represented in a smart contract.

After its creation, the hash of the number or other EHRD will be signed by the registrar.

In a fifth operation (“5. number_hash, registrar_signature”), the hash of the number or other EHRD as well as the signature over the number or other EHRD are sent back to the application 116 that requested the number or other EHRD. In at least some embodiments, by signing the number or other EHRD, the number or other EHRD can be registered on a blockchain. Since the blockchain is controlled by the registrar or related infrastructure, other actors, which may be bad actors, can be denied permission to write to the blockchain because these other actors are not able to produce signed numbers or other EHRD's. Since the registrar 118 is the subscriber of record, only the registrar is permitted to maintain and manage the blockchain.

The application 116 receives the number or other EHRD hash and the signature from the registrar, and in a first part of a sixth operation (“6a. sign transaction to register number in smart contract”), the application 116 creates a transaction to the blockchain. The application 116 also signs the created transaction to prepare the number or other EHRD for registration on the blockchain.

In a second part of a sixth operation (“6b. register number: user_public_key, number_hash, registrar_signature, user_tx_signature”), the application 116 sends the signed transaction to the blockchain. The signed transaction includes the public key of the user 102, the hashed number or other EHRD, the registrar's signature, and the user's signature, and this data is sent to the blockchain smart contract 122.

In a seventh operation (“7. The smart contract confirms”), app logic 120 of the application 116 performs a validation of the user's signature to ensure that the transaction is valid. This validation confirms that the user 102 in position of the communication device 104 that is running the application 116 is in possession of the public key used to sign the transaction (e.g., at the first part of the sixth operation). Also in the seventh operation, the app logic 120 performs a validation of the registrars signature. This operation is possible because the registrar's public key in the smart contract, and this second validation prevents other users from registering invalid numbers or other EHRD's on the blockchain. Further in the seventh operation, the app logic 120 generates a unique profile picture (“pfp”) or other discernible data. Finally, as shown in the matrix of FIG. 3, the smart contract stores the “Public Number Hash,” the “Controller Public Key,” and a value such as a pointer or link to the profile picture or other discernible data (“Link to PFP”).

In some exemplary cases, the value stored on the blockchain that represents the pointer or link to the profile picture or other discernible data using INTERPLANETARY FILE SYSTEM (IPFS) tools. This IPFS protocol, when used in the present embodiment creates a very strong hash over the profile picture or other discernible data. In one exemplary cases, a system-wide or even globally unique image can be expressly associated with the number or other EHRD that was registered by the user 102 operating the application 116.

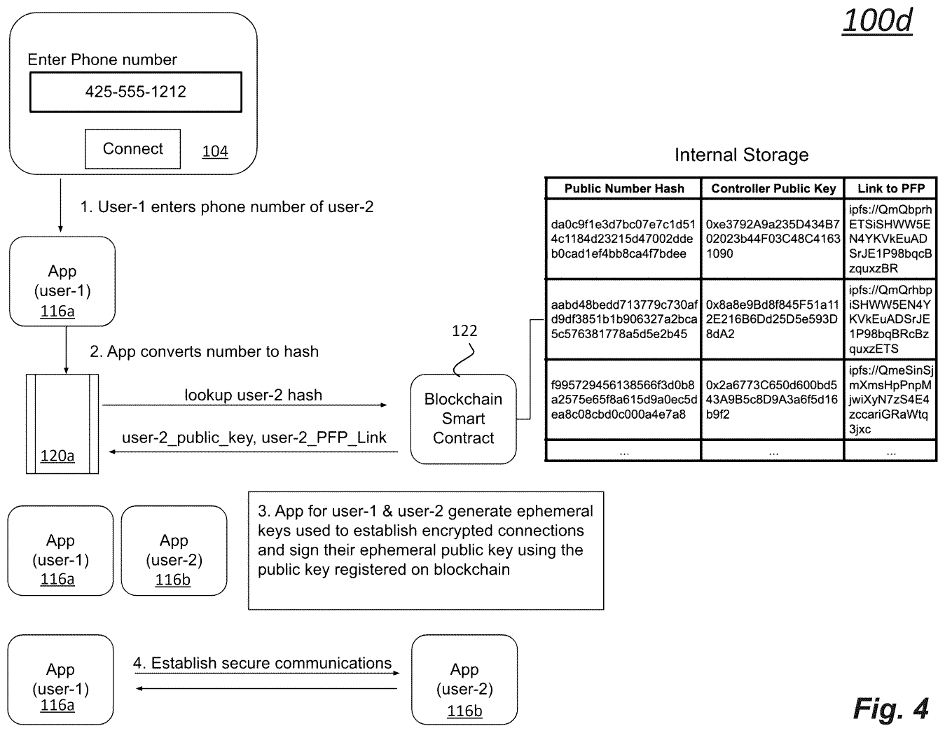

FIG. 4 is a fourth computational environment 100d embodiment arranged to securely communicate with another user. In this fourth computational environment 100d, two users 102a, 102b (FIG. 1) may use any suitable number and type of communication devices 104 (FIG. 2), remote computing servers 112, and database structures 114 to perform the acts of the embodiment that provide secure and private messaging. The logic presented herein operates on the electronic circuitry described herein to improve the security of the communicating hardware circuitry.

In the environment, the first user 102a is operating a communications device 104, which may be arranged as a smartphone, tablet, or other mobile or non-mobile computing device. The communication device 104 is executing an application 116a, which is along the lines of the application 116 of FIG. 3.

In a first operation (“1. User-1 enters phone number of user-2”), via a user interface (e.g., touch screen, keyboard, microphone, or some other user interface) of the communications device 104, the first user 102a enters a telephone number or some other number or EHRD associated with the second user 102b. The input number other EHRD may be typed in, spoken in, received computationally from another computing device, or input in some other way. In this embodiment, the telephone number or other number or EHRD is a secure EHRD associated with the second user 102b and earlier registered for secure use (FIG. 3).

In a second operation (“2. App converts number to hash”), the application 116a of the first user 102a computes a hash of the number or other EHRD to convert the number or other EHRD to an integer. The integer is looked up using the app logic 120a of application 116a on the blockchain smart contract 122. Based on the result of the lookup, if the integer is not found, it is determined that the number or other EHRD has not been registered.

If the number or other EHRD has not been registered, any suitable number of actions may be performed. For example, a message may be presented to the first user 102 via the user interface. As another example, the message may be communicated via a conventional communications means instead of the secure communications means described herein. As an Alternative, the first user 102a or second user 102b may be invited to registered the number or other EHRD (FIG. 3).

If the number or other EHRD has been registered, the blockchain smart contract 122 returns the public key associated with the hash of the number or other EHRD associated with the second user 102b and the PFP associated with the hash. Stated another way, the blockchain smart contract 122 does a lookup in the internal storage based on the hash (i.e., Public Number Hash). If a match is found, the blockchain smart contract 122 returns the controlling public key (i.e., Controller Public Key) and the PFP value, which may be a pointer or link to a profile picture or other discernible data (i.e., Link to PFP), a uniform resource locator (URL), or some other datum that leads or may be otherwise followed to an EHRD.

In a third operation (“3. App for user-1 & user-2 generate ephemeral keys (e.g., key pairs used for establishing Diffie-Helman key exchange, and signs the public key using the first user 102a public address registered on the blockchain smart contract 122) used to establish encrypted connections and further used to sign their ephemeral public key using the public key registered on blockchain. The applications 116a, 116b of the first and second users 102a, 102b respectively, generate one or more ephemeral keys or key pairs used to establish encrypted communication. These ephemeral keys may be used forever, generated once, or formed or retrieved in some other way. The public key for each ephemeral key is signed by the application's controller key (i.e., Controller Public Key) retrieved during the second operation and associated with the secure number or other EHRD.

In a fourth operation (“4. Establish secure communications”), the ephemeral keys, which have been signed by the corresponding public key that has been registered on the blockchain smart contract 122, are used to begin secure communications. Stated differently, the number or other EHRD (e.g., a secure phone number) is associated with a controller public key from the internal storage, which may be a database structure 114 (FIG. 2). The controller public key associated with a particular number or other EHRD of a particular user 102a, 102b is used to sign the ephemeral key of that particular user 102a, 102b. In this way, when secure communications are being established, the identity of each user 102a, 102b can be confirmed with an acceptable level of confidence. Such confirmation may include looking up the signature of the ephemeral public key to determine that the key was validly signed by the controller public key for the number or other EHRD.

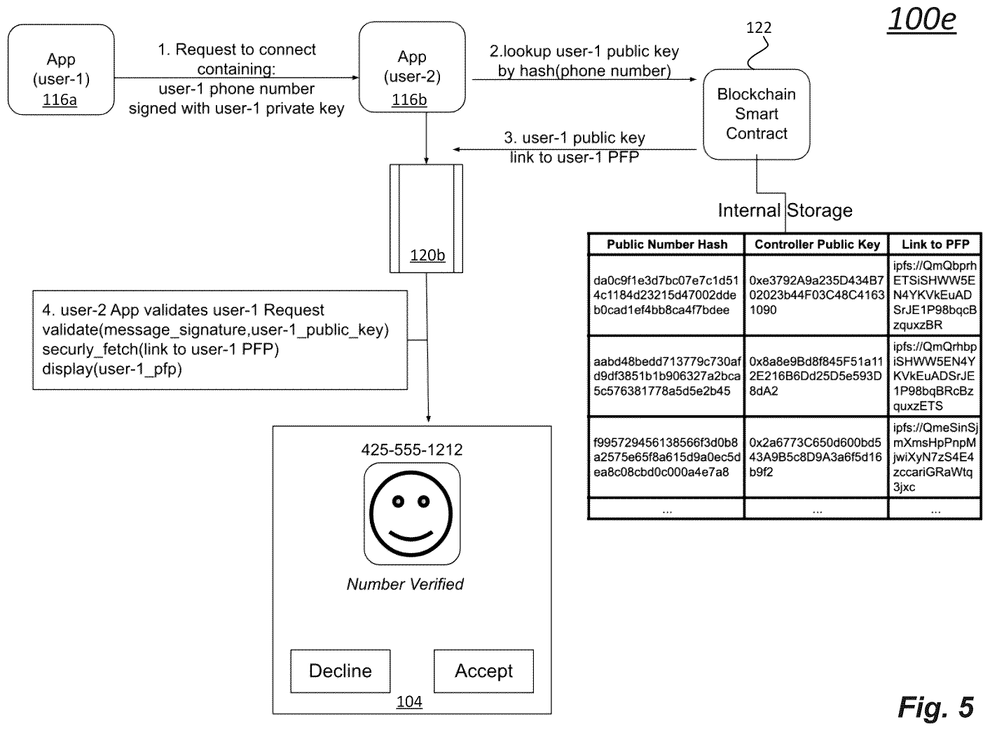

FIG. 5 is a fifth computational environment 100e embodiment arranged to verify contact information from a person or entity not previously known. securely communicate with another user. In some cases, this process of the fifth computational environment 100e embodiment may be referred to as a “friend request,” an “invitation,” or some other term. The fifth computational environment 100e includes two users 102a, 102b (FIG. 1), but any suitable number of users 102n using any suitable number and type of communication devices 104 (FIG. 2), remote computing servers 112, and database structures 114 may be deployed. The logic presented herein operates on the electronic circuitry described herein to improve the security of the communicating hardware logic.

In a first operation (“1. Request to connect containing: user-1 phone number signed with user-1 private key”), a first user 102a uses a first application 116a to reach out and request a connection to a second application 116 associated with a second user 102b. The first and second users 102a, 102b may be one or more human users, one or more computing devices, one or more software applications, or some type or types of users. In one exemplary case, the first and second users 102a, 102b are human users that do not have a previous or pre-existing relationship (e.g., the users met in a coffee shop and would like to verify each other's identity, the users met online and would like to conduct a conversation or transaction with a verified user, or some other relationship). The human users may be in close proximity to each other, or they may be very far apart. By following the acts of the fifth computational environment 100e embodiment, the second user 102b, via the second application 116b, can be sure that the communications were initiated by the first user 102a and verified by a number or other EHRD (e.g., a profile picture) associated with the first user 102a.

The first application 116a of the first user 102a sends the request to the second application 116b of the second user 102b to connect for the first time. The first-time request includes the number or other EHRD, which has been signed with a private key of the first user 102a. The private key of the first user 102a is associated with the public key (e.g., Controller Public Key) that was stored in the internal storage (e.g., database structure 114) when the number or other EHRD was registered.

In a second operation (“2. Lookup user-1 public key by hash (phone number)”), the second application 116b associated with the second user 102b hashes the number or other EHRD received in the request and uses the hashed value to search the blockchain smart contract 122 for an identical hash of the number or other EHRD.

If a result of the inquiry into the blockchain smart contract 122 does not find the hashed value, then the process is terminated. In this case, the first user 102a is not registered, so there is no legitimate secure way in this system for the second user 102b to verify the first user 102a.

If a result of the inquiry into the blockchain smart contract 122 does find the hashed value, a third operation (“3. user-1 public key link to user-1 PFP”) is performed. In the third operation, the public controller key (Controller Public Key) is returned to the second application 116b and the PFP associated with the hash, which may be a pointer or link to a profile picture or other discernible data (i.e., Link to PFP), a uniform resource locator (URL), or some other datum that leads or may be otherwise followed to an EHRD, is also returned.

Having received the public key and the PFP from the blockchain smart contract 122, the second application 116b is assured that the connection request from the first application 116a was validly signed by the first user 102a and that the first user 102a is validly registered.

In a fourth operation (“4. User-2 App validates user-1 Request validate (message_signature,user-1_public_key) securely_fetch (link to user-1 PFP) display (user-1_pfp)”), the app logic 120b uses the PFP associated with the hash, which may be a pointer or link to a profile picture or other discernible data (i.e., Link to PFP), a uniform resource locator (URL), or some other datum that leads or may be otherwise followed to an EHRD, to retrieve the discernible data associated with the first user 102a. In at least some cases, the discernible data is, for example, a profile picture associated with the first user 102a and the number or other EHRD communicated toward the second user 102b via applications 116a, 116b. In the embodiment of FIG. 5, the communication device 104 associated with the second user 102b presents the profile picture of user 102a on an display. The second user 102b is given a choice of whether or not to accept the connection request.

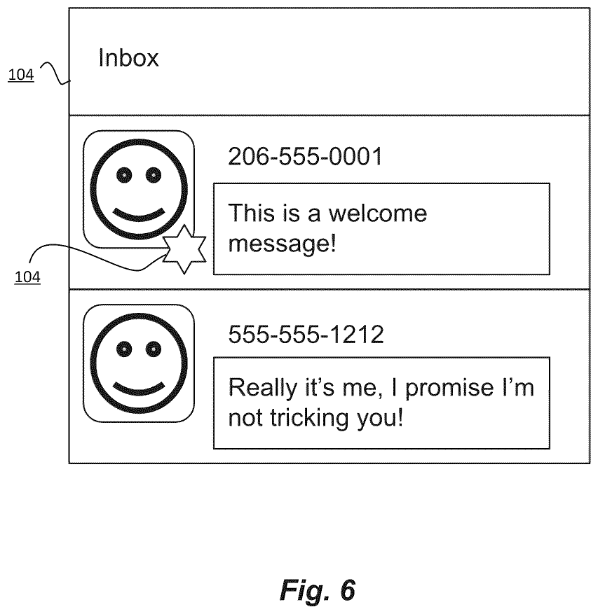

FIG. 6 is an embodiment of a communication device 104 of the type disclosed in the present disclosure. More particularly, the embodiment represents a user interface through which information may be communicated to or from a user 102. In the embodiment, the user 102 is presented with one or more numbers and one or more other EHRD (e.g., telephone numbers, email addresses, uniform resource locators, profile pictures, or the like). In the embodiment, an indicator 124 is presented to the user 102 to indicate that the user associated with the indicator 124 has been verified.

Having now set forth certain embodiments, further clarification of certain terms used herein may be helpful to providing a more complete understanding of that which is considered inventive in the present disclosure.

Various figures include data flow diagrams illustrating non-limiting processes that may be used by embodiments of a computational embodiment for secure communications as described herein. In this regard, each described process may represent a module, segment, or portion of software code, which comprises one or more executable instructions for implementing the specified logical function(s). It should also be noted that in some implementations, the functions noted in the process may occur in a different order, may include additional functions, may occur concurrently, and/or may be omitted.

The figures in the present disclosure illustrate portions of one or more non-limiting computing device embodiments such as one or more components of computational environments 100a-100e, communication devices 104, and remote computing servers 112. The computing devices may include operative hardware found in conventional computing device apparatuses such as one or more processors, volatile and non-volatile memory, serial and parallel input/output (I/O) circuitry compliant with various standards and protocols, wired and/or wireless networking circuitry (e.g., a communications transceiver), one or more user interface (UI) modules, logic, and other electronic circuitry.

Processing devices, or “processors,” as described herein (e.g., processor 106), include central processing units (CPU's), microcontrollers (MCU), digital signal processors (DSP), application specific integrated circuits (ASIC), peripheral interface controllers (PIC), systems-on-chip (SOC), state machines, and the like. Accordingly, a processor as described herein includes any device, system, or part thereof that controls at least one operation, and such a device may be implemented in hardware, firmware, or software, or some combination of at least two of the same. The functionality associated with any particular processor may be centralized or distributed, whether locally or remotely. Processors may interchangeably refer to any type of electronic control circuitry configured to execute programmed software instructions. The programmed instructions may be high-level software instructions, compiled software instructions, assembly-language software instructions, object code, binary code, micro-code, or the like. The programmed instructions may reside in internal or external memory or may be hard-coded as a state machine or set of control signals. According to methods and devices referenced herein, one or more embodiments describe software executable by the processor, which when executed, carries out one or more of the method acts.

The present application discusses several embodiments that include or otherwise cooperate with one or more computing devices. It is recognized that these computing devices are arranged to perform one or more algorithms to implement various concepts taught herein. Each of said algorithms is understood to be a finite sequence of steps for solving a logical or mathematical problem or performing a task. Any or all of the algorithms taught in the present disclosure may be demonstrated by formulas, flow charts, data flow diagrams, narratives in the specification, and other such means as evident in the present disclosure. Along these lines, the structures to carry out the algorithms disclosed herein include at least one processing device executing at least one software instruction retrieved from at least one memory device. The structures may, as the case may be, further include suitable input circuits known to one of skill in the art (e.g., keyboards, buttons, memory devices, communication circuits, touch screen inputs, and any other integrated and peripheral circuit inputs (e.g., accelerometers, thermometers, light detection circuits and other such sensors)), suitable output circuits known to one of skill in the art (e.g., displays, light sources, audio devices, tactile devices, control signals, switches, relays, and the like), and any additional circuits or other structures taught in the present disclosure. To this end, every invocation of means or step plus function elements in any of the claims, if so desired, will be expressly recited.

As known by one skilled in the art, a computing device has one or more memories, and each memory comprises any combination of volatile and non-volatile computer-readable media for reading and writing. Volatile computer-readable media includes, for example, random access memory (RAM). Non-volatile computer-readable media includes, for example, read only memory (ROM), magnetic media such as a hard-disk, an optical disk, a flash memory device, a CD-ROM, and/or the like. In some cases, a particular memory is separated virtually or physically into separate areas, such as a first memory, a second memory, a third memory, etc. In these cases, it is understood that the different divisions of memory may be in different devices or embodied in a single memory. The memory in some cases is a non-transitory computer medium configured to store software instructions arranged to be executed by a processor. Some or all of the stored contents of a memory may include software instructions executable by a processing device to carry out one or more particular acts.

The computing devices illustrated herein may further include operative software found in a conventional computing device such as an operating system or task loop, software drivers to direct operations through I/O circuitry, networking circuitry, and other peripheral component circuitry. In addition, the computing devices may include operative application software such as network software for communicating with other computing devices, database software for building and maintaining databases, and task management software where appropriate for distributing the communication and/or operational workload amongst various processors. In some cases, the computing device is a single hardware machine having at least some of the hardware and software listed herein, and in other cases, the computing device is a networked collection of hardware and software machines working together in a server farm to execute the functions of one or more embodiments described herein. Some aspects of the conventional hardware and software of the computing device are not shown in the figures for simplicity.

Amongst other things, one or more of the exemplary computing devices of the present disclosure (e.g., the authorization circuit 410 of FIG. 1 and at least some portions or modules of the access circuit 410 of FIG. 1, such as processors 406, 456 and memories 408, 458) may be configured in any type of mobile or stationary computing device such as a remote cloud computer, a computing server, a smartphone, a tablet, a laptop computer, a wearable device (e.g., eyeglasses, jacket, shirt, pants, socks, shoes, other clothing, hat, helmet, other headwear, wristwatch, bracelet, pendant, other jewelry), vehicle-mounted device (e.g., train, plane, helicopter, unmanned aerial vehicle, unmanned underwater vehicle, unmanned land-based vehicle, automobile, motorcycle, bicycle, scooter, hover-board, other personal or commercial transportation device), industrial device (e.g., factory robotic device, home-use robotic device, retail robotic device, office-environment robotic device), a power cube, or the like. Accordingly, the computing devices include other components and circuitry that is not illustrated, such as, for example, a display, a network interface, memory, one or more central processors, camera interfaces, audio interfaces, and other input/output interfaces. In some cases, the exemplary computing devices may also be configured in a different type of low-power device such as a mounted video camera, an Internet-of-Things (IoT) device, a multimedia device, a motion detection device, an intruder detection device, a security device, a crowd monitoring device, or some other device.

When so arranged as described herein, each computing device may be transformed from a generic and unspecific computing device to a combination device arranged comprising hardware and software configured for a specific and particular purpose such as to provide a determined technical solution. When so arranged as described herein, to the extent that any of the inventive concepts described herein are found by a body of competent adjudication to be subsumed in an abstract idea, the ordered combination of elements and limitations are expressly presented to provide a requisite inventive concept by transforming the abstract idea into a tangible and concrete practical application of that abstract idea.

The embodiments described herein use computerized technology to improve the technology of network-style computing, but there are other techniques and tools that remain available to implement run-time dynamic computing. Therefore, the claimed subject matter does not foreclose the whole or even substantial network-style computing technological area. The innovation described herein uses both new and known building blocks combined in new and useful ways along with other structures and limitations to create something more than has heretofore been conventionally known. The embodiments improve on computing systems which, when un-programmed or differently programmed, cannot perform or provide the specific locally performed, server-side system features claimed herein. The embodiments described in the present disclosure improve upon known network-style processes and techniques. The computerized acts described in the embodiments herein are not purely conventional and are not well understood. Instead, the acts are new to the industry. Furthermore, the combination of acts as described in conjunction with the present embodiments provides new information, motivation, and business results that are not already present when the acts are considered separately. There is no prevailing, accepted definition for what constitutes an abstract idea. To the extent the concepts discussed in the present disclosure may be considered abstract, the claims present significantly more tangible, practical, and concrete applications of said allegedly abstract concepts. And said claims also improve previously known computer-based systems that perform network-style operations.

Software may include a fully executable software program, a simple configuration data file, a link to additional directions, or any combination of known software types. When a computing device updates software, the update may be small or large. For example, in some cases, a computing device downloads a small configuration data file as part of a software update, and in other cases, a computing device completely replaces most or all of the present software on itself or another computing device with a fresh version. In some cases, software, data, or software and data is encrypted, encoded, and/or otherwise compressed for reasons that include security, privacy, data transfer speed, data cost, or the like.

Database structures, such as database structure 114, may be formed in a single database or multiple databases. In some cases, hardware or software storage repositories are shared amongst various functions of the particular system or systems to which they are associated. A database may be formed as part of a local system or local area network. Alternatively, or in addition, a database may be formed remotely, such as within a distributed “cloud” computing system, which would be accessible via a wide area network or some other network.

Input/output (I/O) circuitry and user interface (UI) modules include serial ports, parallel ports, universal serial bus (USB) ports, IEEE 802.11 transceivers and other transceivers compliant with protocols administered by one or more standard-setting bodies, displays, projectors, printers, keyboards, computer mice, microphones, micro-electro-mechanical (MEMS) devices such as accelerometers, and the like.

In at least one embodiment, devices such as DPA 400 or some other module or circuit may communicate with other devices via communication over a network. The network may involve an Internet connection or some other type of local area network (LAN) or wide area network (WAN). Non-limiting examples of structures that enable or form parts of a network include, but are not limited to, an Ethernet, twisted pair Ethernet, digital subscriber loop (DSL) devices, wireless LAN, Wi-Fi, Worldwide Interoperability for Microwave Access (WiMax), or the like.

In the present disclosure, memory may be used in one configuration or another. The memory may be configured to store data. In the alternative or in addition, the memory may be a non-transitory computer readable medium (CRM). The CRM is configured to store computing instructions executable by a processor 106 (FIG. 2) of a communications device 104 or a processor of a remote computing server 112 or yet some other processor. The computing instructions may be stored individually or as groups of instructions in files. The files may include functions, services, libraries, and the like. The files may include one or more computer programs or may be part of a larger computer program. Alternatively, or in addition, each file may include data or other computational support material useful to carry out the computing functions of an improved network computing system.

Buttons, keypads, computer mice, memory cards, serial ports, bio-sensor readers, touch screens, and the like may individually or in cooperation be useful to a software practitioner programming the improved network computing system. The devices may, for example, input control information into the system. Displays, printers, memory cards, LED indicators, temperature sensors, audio devices (e.g., speakers, piezo device, etc.), vibrators, and the like are all useful to present output information to the software practitioner operating the improved network computing system. In some cases, the input and output devices are directly coupled to a local computing device. and electronically coupled to a processor or other operative circuitry. In other cases, the input and output devices pass information via one or more communication ports (e.g., RS-232, RS-485, infrared, USB, etc.).

As described herein, for simplicity, a user may in some cases be described in the context of the male gender. It is understood that a software practitioner can be of any gender, and the terms “he,” “his,” and the like as used herein are to be interpreted broadly inclusive of all known gender definitions. As the context may require in this disclosure, except as the context may dictate otherwise, the singular shall mean the plural and vice versa; all pronouns shall mean and include the person, entity, firm or corporation to which they relate; and the masculine shall mean the feminine and vice versa.

The terms, “real-time” or “real time,” as used herein and in the claims that follow, are not intended to imply instantaneous processing, transmission, reception, or otherwise as the case may be. Instead, the terms, “real-time” and “real time” imply that the activity occurs in a digital fashion over an acceptably short period of time (e.g., over a period of microseconds or milliseconds), and that the activity may be performed on a constant or otherwise digitally ongoing basis (e.g., maintaining a persistent actual or virtual connection with a remote computing server). An example of an activity that is not real-time is one that occurs over an extended period of time (e.g., hours or days) or that occurs based on intervention or direction by a software practitioner or other activity.

In the absence of any specific clarification related to its express use in a particular context, where the terms “substantial” or “about” or any of their cognates are used as modifiers in the present disclosure and any appended claims (e.g., to modify a structure, a dimension, a measurement, or some other characteristic), it is understood that the characteristic may vary by up to 30 percent. For example, a time between messages may be described as being about a half-second. In these cases, a message interval that is exactly one-half second is exactly 500 milliseconds. Different from the exact precision of the term, “half-second,” the use of “substantially” or “about” to modify the characteristic permits a variance of the “half-second” characteristic by up to 30 percent. Accordingly, a messaging interval that is about a half-second includes messaging intervals between 350 milliseconds and 650 milliseconds.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, the technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

In the present disclosure, when an element (e.g., component, circuit, device, apparatus, structure, layer, material, or the like) is referred to as being “on,” “coupled to,” or “connected to” another element, the elements can be directly on, directly coupled to, or directly connected to each other, or intervening elements may be present. In contrast, when an element is referred to as being “directly on,” “directly coupled to,” or “directly connected to” another element, there are no intervening elements present.

The terms “include” and “comprise,” as well as derivatives and variations thereof, in all of their syntactic contexts, are to be construed without limitation in an open, inclusive sense, (e.g., “including, but not limited to”). The term “or,” is inclusive, meaning and/or. The phrases “associated with” and “associated therewith,” as well as derivatives thereof, can be understood as meaning to include, be included within, interconnect with, contain, be contained within, connect to or with, couple to or with, be communicable with, cooperate with, interleave, juxtapose, be proximate to, be bound to or with, have, have a property of, or the like.

Reference throughout this specification to “one embodiment” or “an embodiment” and variations thereof means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the present disclosure, the terms first, second, etc., may be used to describe various elements, however, these elements are not to be limited by these terms unless the context clearly requires such limitation. These terms are only used to distinguish one element from another. For example, a first machine could be termed a second machine, and, similarly, a second machine could be termed a first machine, without departing from the scope of the inventive concept.

The singular forms of “a,” “an,” and “the” in the present disclosure include plural referents unless the content and context clearly dictates otherwise. The conjunctive terms, “and” and “or,” are generally employed in the broadest sense to include “and/or” unless the content and context clearly dictates inclusivity or exclusivity as the case may be. The composition of “and” and “or” when recited herein as “and/or” encompasses an embodiment that includes all of the elements associated thereto and at least one more alternative embodiment that includes fewer than all of the elements associated thereto.

In the present disclosure, conjunctive lists make use of a comma, which may be known as an Oxford comma, a Harvard comma, a serial comma, or another like term. Such lists are intended to connect words, clauses, or sentences such that the thing following the comma is also included in the list.

The headings and Abstract of the Disclosure provided herein are for convenience only and do not interpret the scope or meaning of the embodiments.

This application claims the benefit of priority to U.S. Provisional Application No. 63/362,456, filed Apr. 4, 2022, which application is hereby incorporated by reference in its entirety to the fullest extent permitted by the prevailing law.

In the description herein, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order to avoid obscuring the description with unnecessary detail. Thus, the present disclosure is not intended to be limited to the embodiments shown but is instead to be accorded the widest scope consistent with the principles and features disclosed herein. Hence, these and other changes can be made to the embodiments in light of the above-detailed description. In general, in the following claims, the terms used should not be construed to limit the claims to the specific embodiments disclosed in the specification but should be construed to include all possible embodiments along with the full scope of equivalents to which such claims are entitled. Accordingly, the claims are not limited by the disclosure.

1. A mobile device secure communications method, comprising:
providing a first secure communications application in a memory device of a first mobile computing device; and
executing software instructions of the first secure communications application, wherein the executing is arranged to carry out the acts of:
requesting at least one identification number;
selecting an identification number from the at least one identification number;
receiving a hash of the identification number from a registrar, the registrar having signed the hash of the identification number;
signing a transaction involving the identification number; and
directing registration of the hashed and signed version of the identification number on a blockchain smart contract using a public key controlled with a private key associated with a first user, wherein the registering causes the registrar to store a public number hash of the identification number, a controller public key associated with the identification number, and a representation of a first encoded human readable datum (EHRD) associated with the identification number.

2. The mobile device secure communications method according to claim 1 wherein the identification number is a telephone number.

3. The mobile device secure communications method according to claim 1 wherein the identification number is a telephone number having an E.164 format.

4. The mobile device secure communications method according to claim 1 wherein the representation of the first encoded human readable datum (EHRD) is a profile picture having hashed data embedded therein.

5. The mobile device secure communications method according to claim 1 wherein requesting at least one identification number includes requesting at least two identification numbers and wherein selecting the identification number includes selecting one of the at least two identification numbers.

6. The mobile device secure communications method according to claim 1 wherein the executing software instructions are further arranged to carry out the acts of:
accepting a second identification number at the first mobile computing device;
performing a hash on the second identification number;
directing a look-up to determine if a version of the hashed second identification number is found on the blockchain smart contract;
based on finding the version of the hashed second identification number on the blockchain smart contract, generating ephemeral key pairs; and
using the ephemeral key pairs to establish and conduct encrypted communications between the first mobile computing devices and a second mobile computing device.

7. The mobile device secure communications method according to claim 6 wherein the executing software instructions are further arranged to carry out the acts of:
retrieving a representation of a second encoded human readable datum (EHRD) associated with second the identification number.

8. The mobile device secure communications method according to claim 1 wherein the executing software instructions are further arranged to carry out the acts of:
displaying on a user interface verified and unverified identification numbers.

9. The mobile device secure communications method according to claim 1 wherein the executing software instructions are further arranged to carry out the acts of:
receiving at the first secure communications application a request to connect, the request including a third identification number signed with a private key;
performing a hash on the third identification number;
directing a look-up to determine if a version of the hashed third identification number is found on the blockchain smart contract; and
based on finding the version of the hashed third identification number on the blockchain smart contract, providing the first user with an opportunity to accept the request to connect.

10. The mobile device secure communications method according to claim 9 wherein the executing software instructions are further arranged to carry out the acts of:
based on finding the version of the hashed third identification number on the blockchain smart contract, retrieving a representation of a third encoded human readable datum (EHRD) associated with the third identification number.

11. A non-transitory computer-readable storage medium whose stored contents configure a computing system to perform a method, the method comprising:
processing digital information from a first device, said information including a request from the first device to access to a first descriptor file;
isolating a human readable datum arranged as a set of N alphanumeric digits, wherein N is an integer greater than 7;
encoding the human readable datum into a first encoded human readable datum (EHRD), the first EHRD being arranged as a system-wide unique M-bit alphanumeric sequence, wherein M is an integer greater than N;
determining whether the first EHRD is present on a certain blockchain, the certain blockchain hosting a system-wide registry of EHRDs;
based on a successful determination that the first EHRD is present on the certain blockchain, retrieving a first system-wide unique L-bit hash from a determined distributed hash table (DHT) structure, wherein L is an integer greater than M; and
using the first system-wide unique L-bit hash, communicating the first descriptor file or information associated with the first descriptor file to the first device requesting access to the first descriptor file.

12. The non-transitory computer-readable storage medium according to claim 11 wherein N is at least 15, M is at least 48, and L is at least 256.

13. The non-transitory computer-readable storage medium according to claim 11 wherein the human readable datum represents a numeric telephone number.

14. The non-transitory computer-readable storage medium according to claim 11 whose stored contents configure the computing system to perform the method, the method further comprising:
retrieving, from the descriptor file, communication parameters associated with communicating data between a second device and the first device.
